(19) United States
(12) Patent Application Publication
(10) Pub. No.: US 2021/0151850 A1
(43) Pub. Date: May 20, 2021

(54) POWER DIVIDER/COMBINER

(71) Applicant: MITSUBISHI ELECTRIC CORPORATION, Tokyo (JP)

(72) Inventors: Hideharu YOSHIOKA, Tokyo (JP); Hiroyuki AOYAMA, Tokyo (JP); Naofumi YONEDA, Tokyo (JP); Tetsuro ASHIDA, Tokyo (JP)

(73) Assignee: MITSUBISHI ELECTRIC CORPORATION, Tokyo (JP)

(21) Appl. No.: 16/606,142

(22) PCT Filed: Jun. 28, 2017
(86) PCT No.: PCT/JP2017/023806

§ 371 Date: Oct. 17, 2019

(51) Int. Cl. H01P 5/19; H01P 3/08

(52) U.S. Cl. CPC H01P 5/19; H01P 3/08

(57) ABSTRACT

According to the present invention, there is provided a power divider/combiner in which two transmission lines configured to connect between respective input/output terminals and an isolation resistor are at least partially adjusted to have suitable impedances during an even-mode operation and an odd-mode operation, for each of the even mode operation and the odd mode operation, to thereby ensure satisfactory reflection characteristics at the respective input/output terminals during the odd-mode operation, a satisfactory reflection characteristic at a common terminal during the even-mode operation, and satisfactory reflection characteristics at the respective input/output terminals during the even-mode operation over a wide band.

### TECHNICAL FIELD

The present invention relates to a power divider/combiner configured to divide or combine mainly high frequency signals of a microwave band and a millimeter wave band.

### BACKGROUND ART

Generally, power dividers/combiners are widely used to divide or combine high frequency signals. Of those, a Wilkinson power divider/combiner and a Gysel power divider/combiner are used when it is required, in a divider function mode and a combiner function mode, to ensure isolation between output terminals and isolation between input terminals, respectively.

The related-art Wilkinson power divider/combiner includes one common terminal and two input/output terminals. The common terminal becomes an input terminal during a signal distributing operation, and becomes an output terminal during a signal synthesizing operation. The two input/output terminals become output terminals during the signal distributing operation, and become input terminals during the signal synthesizing operation.

The common terminal and each of the input/output terminals are connected to each other via a quarter-wavelength (λ/4 where λ represents a wavelength of an operating center frequency) impedance transformer. Further, the input/output terminals are connected to each other via a single isolation resistor called “absorption resistor” (see, for example, Non-Patent Literature 1).

There is also a related-art Wilkinson power divider/combiner including a coupling line between a divider input terminal and a divider output terminal, for example (see, for example, Patent Literature 1). In the power divider/combiner described in Patent Literature 1, a coupling line for phase velocity difference compensation is provided between the divider input terminal and the coupling line, to thereby achieve the same electrical length in an even mode and an odd mode. The thus-configured power divider/combiner ensures satisfactory reflection and isolation.

Further, there is an example of the Wilkinson power divider/combiner described above, in which a transmission line is provided between each of input/output terminals and an isolation resistor, and the respective transmission lines have an electric length that is half (λ/2) the wavelength of the operating frequency, or is any natural number of times longer than the half wavelength (see, for example, Patent Literature 2).

The power divider/combiner described in Patent Literature 2 employs a configuration of a transmission line in which a phase difference between a route that connects two input/output terminals via two quarter-wavelength impedance transformers and a route that connects two input/output terminals via an isolation resistor is an odd multiple of 180 degrees on a power propagation route that connects the input/output terminals, to thereby achieve improvement of a degree of design freedom.

The term “natural number of times longer than the half wavelength” as used herein refers to an integral multiple (1, 2, 3, . . . ) excluding 0 and negative integers (the same applies hereinafter).

A related-art Gysel power divider/combiner includes one common terminal and two input/output terminals. The common terminal serves as an input terminal during a signal distributing operation, and serves as an output terminal during a signal synthesizing operation. The two input/output terminals serve as output terminals during the signal distributing operation, and serve as input terminals during the signal synthesizing operation. The common terminal and each of the input/output terminals are connected to each other via a quarter-wavelength impedance transformer.

Further, the input/output terminals are connected to each other via a transmission line having a length corresponding to one wavelength, and also are each connected to one isolation resistor grounded at a position far from the input/output terminals by a quarter wavelength (see, for example, Non-Patent Literature 2).

The Gysel power divider/combiner includes two isolation resistors, and one ends of the isolation resistors are grounded. Hence, the Gysel power divider/combiner achieves higher electric power resistance and heat resistance compared with the Wilkinson power divider/combiner.

Further, there is an example of the Wilkinson power divider/combiner and Gysel power divider/combiner described above, in which a plurality of isolation resistors are loaded in parallel (see, for example, Patent Literature 3).

The power divider/combiner described in Patent Literature 3 includes the plurality of isolation resistors and hence, when resistance values thereof vary due to manufacturing errors, degradation of a characteristic of isolation between branch side terminals can be minimized.

### CITATION LIST

### Patent Literature

[PTL 1] JP 58-119203 A
[PTL 2] U.S. Pat. No. 4,875,024 A
[PTL 3] JP 5465102 B2

### Non-Patent Literature

[NPL 1] Ernest. J. Wilkinson, “An N-Way Hybrid Power Divider” (IRE Transactions on Microwave Theory and Techniques, 1960, pp. 116-118)
[NPL 2] Ulrich H. Gysel, “A New N-Way Power Divider/Combiner Suitable for High Power Applications” (MIT Symposium Digest, 1975, pp. 116-118)

### SUMMARY OF INVENTION

### Technical Problem

However, the related-art dividers/combiners described above have the following problems.

Specifically, there is a problem about a fractional bandwidth that ensures satisfactory reflection amount and isolation amount equal to or less than −20 dB. The fractional bandwidth of the general Wilkinson power divider/combiner described in Non-Patent Literature 1 is equal to or less than 40%, and that of the Gysel power divider/combiner is smaller than 40%.

In the power divider/combiner described in Patent Literature 1, the coupling line for phase velocity difference compensation is provided between the divider input terminal and the coupling line. Thus, in the power divider/combiner described in Patent Literature 1, quarter-wavelength impedance transformers can have the same electrical length in an even mode and an odd mode. The thus-configured power divider/combiner ensures satisfactory reflection and isolation.

However, the power divider/combiner, which is of Wilkinson type, has a narrow fractional bandwidth. In this regard, Patent Literature 1 includes neither suggestion nor description about how to extend the fractional bandwidth.

Further, the power divider/combiner described in Patent Literature 2 includes the transmission line that is provided between each of the input/output terminals and the isolation resistor, and has the electrical length that is half the wavelength of the operating frequency, or is any natural number of times longer than the half wavelength. Hence, the power divider/combiner described in Patent Literature 2 enables a higher degree of design freedom. However, the power divider/combiner, which is of Wilkinson type, has a narrow fractional bandwidth. In this regard, Patent Literature 2 includes neither suggestion nor description about how to extend the fractional bandwidth.

The power divider/combiner described in Non-Patent Literature 2, which is of Gysel type, has a narrow fractional bandwidth. In this regard, Non-Patent Literature 2 includes neither suggestion nor description about how to extend the fractional bandwidth.

Further, the power divider/combiner described in Patent Literature 3, which is of Wilkinson and Gysel type, has a narrow fractional bandwidth as well. In this regard, Patent Literature 3 includes neither suggestion nor description about how to extend the fractional bandwidth.

The present invention has been made to solve the above-mentioned problems, and therefore, it is an object of the present invention to achieve a power divider/combiner that ensures satisfactory reflection characteristics at a common terminal and respective input/output terminals and a satisfactory isolation characteristic at the respective input/output terminals over a wide band.

### Solution to Problem

According to one embodiment of the present invention, there is provided a power divider/combiner including: a common terminal, to which a high-frequency signal to be divided is input, or from which a synthesized high-frequency signal is output; a first input/output terminal and a second input/output terminal, from which divided high-frequency signals are output, or to which high-frequency signals to be synthesized are input; a first impedance transformer having one end connected to the common terminal and another end connected to the first input/output terminal; a second impedance transformer having one end connected to the common terminal and another end connected to the second input/output terminal; an isolation resistor configured to avoid interference between a high-frequency signal at the first input/output terminal and a high-frequency signal at the second input/output terminal; a first transmission line and a second transmission line, which are configured to connect the isolation resistor and the first input/output terminal; and a third transmission line and a fourth transmission line, which are configured to connect the isolation resistor and the second input/output terminal, the first transmission line and the second transmission line being cascaded, the third transmission line and the fourth transmission line being cascaded, the first transmission line and the third transmission line being arranged in parallel and close to each other, and also being electrically coupled to form a first coupling line.

According to another embodiment of the present invention, there is provided a power divider/combiner including: a common terminal, to which a high-frequency signal to be divided is input, or from which a synthesized high-frequency signal is output; a first input/output terminal and a second input/output terminal, from which divided high-frequency signals are output, or to which high-frequency signals to be synthesized are input; a first impedance transformer having one end connected to the common terminal and another end connected to the first input/output terminal; a second impedance transformer having one end connected to the common terminal and another end connected to the second input/output terminal; an isolation resistor configured to avoid interference between a high-frequency signal at the first input/output terminal and a high-frequency signal at the second input/output terminal; a first transmission line configured to connect one end of the isolation resistor and the first input/output terminal; a second transmission line configured to connect another end of the isolation resistor and the second input/output terminal; a third transmission line having one end connected to a node between the isolation resistor and the first transmission line; and a fourth transmission line having one end connected to a node between the isolation resistor and the third transmission line, another end of the second transmission line and another end of the fourth transmission line being connected to each other, the first transmission line and the third transmission line being arranged in parallel and close to each other, and also being electrically coupled to form a first coupling line.

According to still another embodiment of the present invention, there is provided a power divider/combiner including: a common terminal, to which a high-frequency signal to be divided is input, or from which a synthesized high-frequency signal is output; a first input/output terminal and a second input/output terminal, from which divided high-frequency signals are output, or to which high-frequency signals to be synthesized are input; a first impedance transformer having one end connected to the common terminal and another end connected to the first input/output terminal; a second impedance transformer having one end connected to the common terminal and another end connected to the second input/output terminal; an isolation resistor configured to avoid interference between a high-frequency signal at the first input/output terminal and a high-frequency signal at the second input/output terminal; a first half-wavelength line configured to connect the isolation resistor and the first input/output terminal; and a second half-wavelength line configured to connect the isolation resistor and the second input/output terminal, the first half-wavelength line including a first transmission line and a second transmission line, the second half-wavelength line including a third transmission line and a fourth transmission line. When a load impedance at the first input/output terminal and a load impedance at the second input/output terminal are represented by “Z0”, and a value that is half a resistance value of the isolation resistor is represented by “R′”, an impedance of the first transmission line and an impedance of the third transmission line are in a range of from Z0 to R′, and an impedance of the second transmission line and an impedance of the fourth transmission line are in a range of from Za to R′, where “Za” represents the impedance of the first transmission line and the impedance of the third transmission line. The first transmission line, the second transmission line, the third transmission line, and the fourth transmission line each operate as an impedance transformer.

### Advantageous Effects of Invention

According to the present invention, the two transmission lines configured to connect between the respective input/output terminals and the isolation resistor are at least partially adjusted to have suitable impedances during an even-mode operation and an odd-mode operation, for each of the even mode operation and the odd mode operation, to thereby ensure satisfactory reflection characteristics at the respective input/output terminals during the odd-mode operation, a satisfactory reflection characteristic at the common terminal during the even-mode operation, and satisfactory reflection characteristics at the respective input/output terminals during the even-mode operation over a wide band. This enables a power divider/combiner that has satisfactory reflection characteristics at a common terminal and respective input/output terminals and a satisfactory isolation characteristic at the respective input/output terminals over a wide band.

### BRIEF DESCRIPTION OF DRAWINGS

FIG. 1A is a perspective view of one example of a power divider/combiner according to a first embodiment of the present invention.

FIG. 1B is a top view of the one example of the power divider/combiner according to the first embodiment of the present invention.

FIG. 2 is an equivalent circuit diagram of the power divider/combiner according to the first embodiment of the present invention as illustrated in FIG. 1A and FIG. 1B.

FIG. 3A is a graph for showing a result of simulating an equivalent circuit of a related-art Wilkinson power divider/combiner as disclosed in Non-Patent Literature 1.

FIG. 3B is a graph for showing a result of simulating the equivalent circuit of the power divider/combiner according to the first embodiment of the present invention as illustrated in FIG. 2.

FIG. 4A is a diagram for illustrating the equivalent circuit of the power divider/combiner according to the first embodiment of the present invention as illustrated in FIG. 2, during an odd-mode operation that assumes an electric wall as a plane of symmetry.

FIG. 4B is a diagram for illustrating an equivalent circuit of the power divider/combiner according to the first embodiment of the present invention as illustrated in FIG. 2, during an even-mode operation that assumes a magnetic wall as the plane of symmetry.

FIG. 5A is a chart (Smith chart) for showing a result of simulating the equivalent circuit of the related-art Wilkinson power divider/combiner disclosed in Non-Patent Literature 1, during an even-mode operation and an odd-mode operation.

FIG. 5B is a chart (Smith chart) for showing a result of simulating the equivalent circuit of the power divider/combiner according to the first embodiment of the present invention as illustrated in FIG. 2, during the even-mode operation and the odd-mode operation.

FIG. 6A is a perspective view of a power divider/combiner according to a second embodiment of the present invention, in which two transmission lines between respective input/output terminals and an isolation resistor have electrical lengths that are equal to or less than a quarter wavelength, and are at least partially arranged in parallel and close to each other.

FIG. 6B is a top view of the power divider/combiner according to the second embodiment of the present invention, in which the two transmission lines between the respective input/output terminals and the isolation resistor have electrical lengths that are equal to or less than a quarter wavelength, and are at least partially arranged in parallel and close to each other.

FIG. 7 is an equivalent circuit diagram of the power divider/combiner according to the second embodiment of the present invention as illustrated in FIG. 6A and FIG. 6B.

FIG. 8A is a perspective view of a power divider/combiner according to a third embodiment of the present invention, in which two transmission lines between respective input/output terminals and an isolation resistor are entirely arranged in parallel and close to each other.

FIG. 8B is a top view of the power divider/combiner according to the third embodiment of the present invention, in which the two transmission lines between the respective input/output terminals and the isolation resistor are entirely arranged in parallel and close to each other.

FIG. 9 is an equivalent circuit diagram of the power divider/combiner according to the third embodiment of the present invention as illustrated in FIG. 8A and FIG. 8B.

FIG. 10 is an equivalent circuit diagram of a power divider/combiner according to a fourth embodiment of the present invention.

FIG. 11 is an equivalent circuit diagram of the power divider/combiner according to the fourth embodiment of the present invention, in which two transmission lines are arranged in parallel and close to each other, to thereby form a coupling line.

FIG. 12 is an equivalent circuit diagram of a power divider/combiner according to a fifth embodiment of the present invention.

FIG. 13 is an equivalent circuit diagram of the power divider/combiner according to the fifth embodiment of the present invention, in which two transmission lines are arranged in parallel and close to each other, to thereby form a coupling line.

FIG. 14A is a perspective view of a power divider/combiner according to a sixth embodiment of the present invention, in which two transmission lines between respective input/output terminals and an isolation resistor satisfy Expression (1) and Expression (2), and any one of Expressions (3) to (6).

FIG. 14B is a top view of the power divider/combiner according to the sixth embodiment of the present invention, in which the two transmission lines between the respective input/output terminals and the isolation resistor satisfy Expression (1) and Expression (2), and any one of Expressions (3) to (6).

FIG. 15 is an equivalent circuit diagram of the power divider/combiner according to the sixth embodiment of the present invention as illustrated in FIG. 14A and FIG. 14B.

FIG. 16A is a perspective view of a power divider/combiner according to a seventh embodiment of the present invention, in which strip lines are employed.

FIG. 16B is a top view of the power divider/combiner according to the seventh embodiment of the present invention, in which the strip lines are employed.

### DESCRIPTION OF EMBODIMENTS

Now, a power divider/combiner according to each of embodiments of the present invention is described with reference to the drawings. In each of the embodiments, the same or corresponding portions are denoted by the same reference symbols, and the overlapping description thereof is omitted.

### First Embodiment

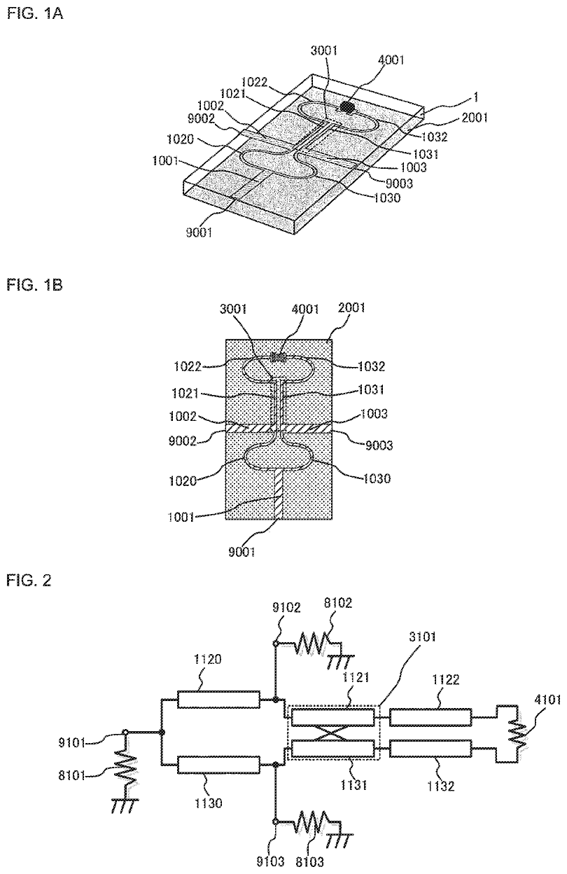

FIG. 1A is a perspective view of one example of a power divider/combiner according to a first embodiment of the present invention. FIG. 1B is a top view of the one example of the power divider/combiner according to the first embodiment of the present invention.

In the first embodiment, a description is given of a Wilkinson power divider/combiner configured as follows.
The power divider/combiner mainly includes a dielectric substrate having a surface layer on which strip conductor patterns are formed, which serve as quarter-wavelength impedance transformers.
On the surface layer, a chip resistor is provided as an isolation resistor, and the strip conductor patterns and the chip resistor are connected via transmission lines formed of strip conductors.
The two transmission lines formed of the strip conductors are arranged in parallel and close to each other, to thereby form a coupling line.

In FIG. 1A and FIG. 1B, one surface of a dielectric layer 1 has formed thereon a common terminal 9001, an input/output terminal 9002, an input/output terminal 9003, a common strip conductor 1001, an input/output strip conductor 1002, an input/output strip conductor 1003, a quarter-wavelength impedance transformer strip conductor 1020, a quarter-wavelength impedance transformer strip conductor 1030, a transmission line strip conductor 1021, a transmission line strip conductor 1022, a transmission line strip conductor 1031, a transmission line strip conductor 1032, and a chip resistor 4001.

A ground conductor 2001 hatched with dots is disposed on an opposite surface to the surface of the dielectric layer 1 on which the chip resistor 4001 is provided.

One end of the common strip conductor 1001 serves as the common terminal 9001, and another end thereof is connected to the quarter-wavelength impedance transformer strip conductor 1020 and the quarter-wavelength impedance transformer strip conductor 1030.

One end of the input/output strip conductor 1002 serves as the common terminal 9002, and another end thereof is connected to the quarter-wavelength impedance transformer strip conductor 1020 and the transmission line strip conductor 1021.

One end of the input/output strip conductor 1003 serves as the common terminal 9003, and another end thereof is connected to the quarter-wavelength impedance transformer strip conductor 1030 and the transmission line strip conductor 1031.

The transmission line strip conductor 1021 is connected to the chip resistor 4001 via the transmission line strip conductor 1022. Meanwhile, the transmission line strip conductor 1031 is connected to the chip resistor 4001 via the transmission line strip conductor 1032.

The transmission line strip conductor 1021 and the transmission line strip conductor 1031 are arranged in parallel and close to each other, to thereby form a coupling line 3001.

FIG. 2 is an equivalent circuit diagram of the power divider/combiner according to the first embodiment of the present invention as illustrated in FIG. 1A and FIG. 1B. As understood from comparison between the configuration views of FIG. 1A and FIG. 1B and the equivalent circuit diagram of FIG. 2, the common terminal 9001, the input/output terminal 9002, and the input/output terminal 9003 of FIG. 1A and FIG. 1B are replaced with a common terminal 9101, an input/output terminal 9102, and an input/output terminal 9103, respectively, in FIG. 2.

Further, the common strip conductor 1001, the input/output strip conductor 1002, and the input/output strip conductor 1003 of FIG. 1A and FIG. 1B are omitted in FIG. 2.

Further, the quarter-wavelength impedance transformer strip conductor 1020, the quarter-wavelength impedance transformer strip conductor 1030, the transmission line strip conductor 1021, the transmission line strip conductor 1022, the transmission line strip conductor 1031, the transmission line strip conductor 1032, and the chip resistor 4001 of FIG. 1A and FIG. 1B are replaced with a quarter-wavelength impedance transformer 1120, a quarter-wavelength impedance transformer 1130, a transmission line 1121, a transmission line 1122, a transmission line 1131, a transmission line 1132, and an isolation resistor 4101, respectively, in FIG. 2.

The common terminal 9101, the input/output terminal 9102, and the input/output terminal 9103 are grounded via a load impedance 8101, a load impedance 8102, and a load impedance 8103, respectively.

In FIG. 1A and FIG. 1B, the transmission line strip conductor 1021 and the transmission line strip conductor 1031 form the coupling line 3001. Meanwhile, in FIG. 2, the transmission line 1121 and the transmission line 1131 form a coupling line 3101.

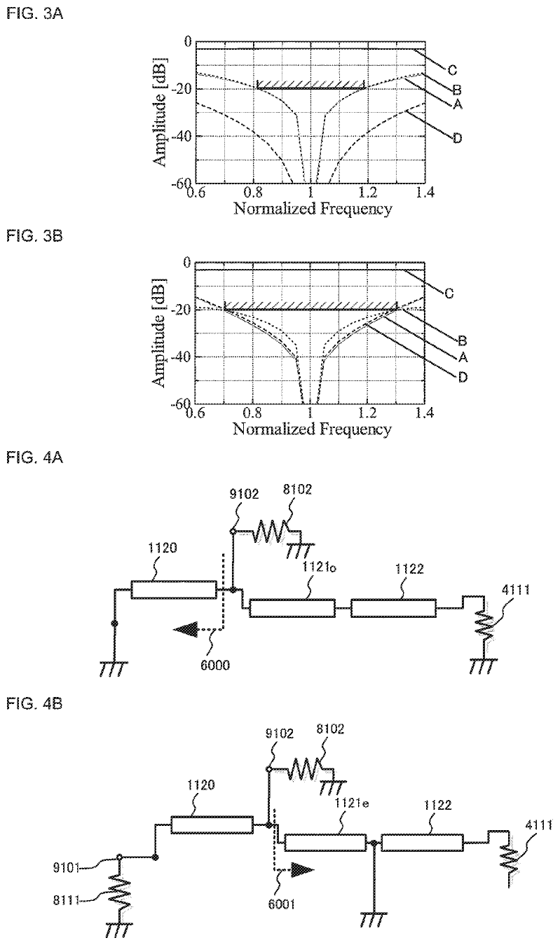

FIG. 3A is a graph for showing a result of simulating an equivalent circuit of a related-art Wilkinson power divider/combiner as disclosed in Non-Patent Literature 1. FIG. 3B is a graph for showing a result of simulating the equivalent circuit of the power divider/combiner according to the first embodiment of the present invention as illustrated in FIG. 2.

Further, the power divider/combiner of the first embodiment, which is simulated as described above, is assumed to have a configuration in which a total length of the transmission line 1121 and the transmission line 1122 is the same as that of the transmission line 1131 and the transmission line 1132, and the total length is any natural number of times longer than a half wavelength.

In FIG. 3A and FIG. 3B, the solid line A, the dotted line B, the solid line C, and the dashed line D indicate the following characteristics. Those characteristics are assumed to be obtained during a power dividing operation.

Solid line A indicates a reflection characteristic at the common terminal 9101.

Dotted line B indicates a reflection characteristic at the input/output terminal 9102 or the input/output terminal 9103.

Solid line C indicates a characteristic of transmission (division) from the common terminal 9101 to the input/output terminal 9102 or to the input/output terminal 9103.

Dashed line D indicates a characteristic of isolation between the input/output terminal 9102 and the input/output terminal 9103.

As apparent from FIG. 3A, the reflection characteristic at the common terminal 9101 as indicated by the solid line A, the reflection characteristic at the input/output terminal 9102 or the input/output terminal 9103 as indicated by the dotted line B, and the characteristic of isolation between the input/output terminal 9102 and the input/output terminal 9103 as indicated by the dashed line D, can be all equal to or less than −20 dB at a frequency band with a band width of about 38% around a normalized frequency of 1 (center frequency) as hatched in FIG. 3A. Specifically, the band width stays equal to or less than 40%.

Meanwhile, as apparent from FIG. 3B, the reflection characteristic at the common terminal 9101 as indicated by the solid line A, the reflection characteristic at the input/output terminal 9102 or the input/output terminal 9103 as indicated by the dotted line B, and the characteristic of isolation between the input/output terminal 9102 and the input/output terminal 9103 as indicated by the dashed line D, can be all equal to or less than −20 dB at a frequency band with a band width of about 60% around a normalized frequency of 1 (center frequency) as hatched in FIG. 3B. It follows that the band width of FIG. 3B can be at least 20% wider than that of FIG. 3A.

FIG. 4A is a diagram for illustrating the equivalent circuit of the power divider/combiner according to the first embodiment of the present invention as illustrated in FIG. 2, during an odd-mode operation that assumes an electric wall as a plane of symmetry.

Further, FIG. 4B is a diagram for illustrating the equivalent circuit of the power divider/combiner according to the first embodiment of the present invention as illustrated in FIG. 2, during an even-mode operation that assumes a magnetic wall as a plane of symmetry.

In FIG. 4A, the plane of symmetry is an electric wall, and hence, the common terminal 9101 is short-circuited. Further, the isolation resistor 4101 of FIG. 2 is replaced with an isolation resistor 4111 having a resistance value that is half the resistance value of the isolation resistor 4101, and also, one end of the isolation resistor 4111 is short-circuited.

Here, the transmission line 1121 of FIG. 2 forms the coupling line 3101 in combination with the transmission line 1131. Thus, during the odd-mode operation of FIG. 4A, the transmission line 1121 is replaced with a transmission line 11210 adopted for the odd-mode operation of the coupling line 3101.

In this case, the common terminal 9101 is short-circuited, and hence, a region from the quarter-wavelength impedance transformer 1120 toward the common terminal 9101 side as indicated by the arrow 6000 is made open.

Further, an impedance value Z0 of the load impedance 8102, a resistance value R′ of the isolation resistor 4111, an impedance value Za of the transmission line 1121o, and an impedance value Zb of the transmission line 1122 satisfy relationships represented by Expressions (1) to (6) below.

$$\begin{matrix}Za = \sqrt[3]{Z {0}^{2} \cdot {R}^{′}} & ( 1 ) \\ Zb = \sqrt[3]{{R}^{′2} \cdot Z 0} & ( 2 )\end{matrix}$$

where when Z0>R′, Z0≥Za>Zb≥R′ (3)

when Z0<R′, Z0≤Za<Zb≤R′ (4)

when Z0=R′,

Z0=R′=Za=Zb (5)

Z0=R′≠Za=Zb (6)

Meanwhile, in FIG. 4B, the plane of symmetry is a magnetic wall, and hence, the load impedance 8101 of FIG. 2 is replaced with a load impedance 8111 having an impedance value that is twice the impedance value of the load impedance 8101. Further, the isolation resistor 4101 of FIG. 2 is replaced with an isolation resistor 4111 having a resistance value that is half the resistance value of the isolation resistor 4101, and also the isolation resistor 4111 is open at one end thereof, and thus can be ignored.

Here, the transmission line 1121 of FIG. 2 forms the coupling line 3101 in combination with the transmission line 1131. Thus, during the even-mode operation of FIG. 4B, the transmission line 1121 is replaced with a transmission line 1121e adopted for the even-mode operation of the coupling line 3101.

In this case, because the isolation resistor 4111 is open at one end thereof, when the transmission line 1122 has the electrical length corresponding to the quarter wavelength, a node between the transmission line 1122 and the transmission line 1121e is short-circuited. Consequently, the electrical length of the transmission line 1121e is an odd multiple of the quarter wavelength, and thus, a region from the transmission line 1121e toward the isolation resistor 4111 side as indicated by the arrow 6001 is made open and ignorable.

Further, when an impedance value Zc of the transmission line 1121e is set higher than the impedance value Z0 of the load impedance 8102 as given by Expression (7) below, the region from the transmission line 1121e toward the isolation resistor 4111 side as indicated by the arrow 6001 can be assumed to be pseudo open not only at the center frequency but also at frequency bands above and below the center frequency, and an influence of that region can be suppressed.

Zc>Z0 (7)

In this way, the band that ensures a satisfactory reflection characteristic at the common terminal 9101 and a satisfactory reflection characteristic at the input/output terminal 9102 in the even-mode operation, can be extended.

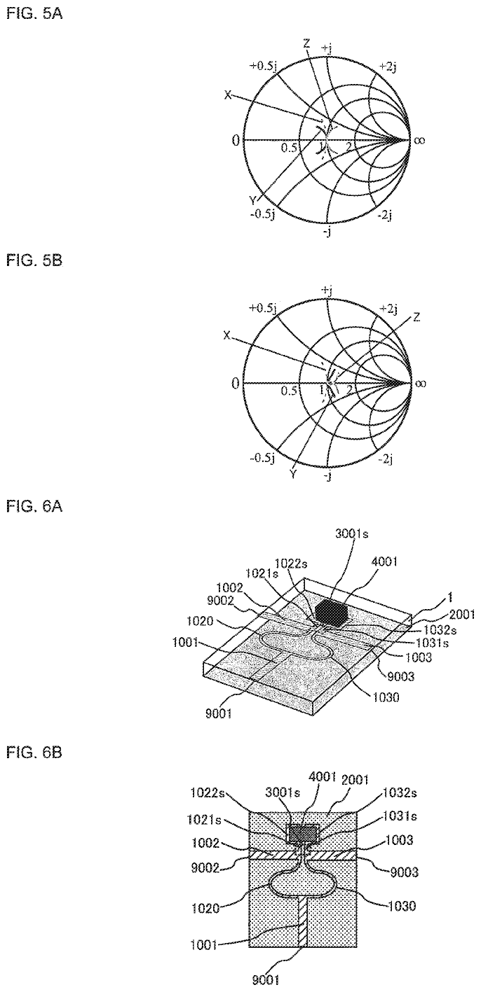

FIG. 5A is a chart (Smith chart) for showing a result of simulating the equivalent circuit of the related-art Wilkinson power divider/combiner disclosed in Non-Patent Literature 1, during an even-mode operation and an odd-mode operation. FIG. 5B is a chart (Smith chart) for showing a result of simulating the equivalent circuit of the power divider/combiner according to the first embodiment of the present invention as illustrated in FIG. 2, during the even-mode operation and the odd-mode operation.

In FIG. 5A and FIG. 5B, the dashed line X, the solid line Y, and the dashed line Z indicate the following characteristics. Those characteristics are assumed to be obtained during a power dividing operation.

Dashed line X indicates a reflection characteristic at the input/output terminal 9102 during the odd-mode operation

Solid line Y indicates a reflection characteristic at the common terminal 9101 during the even-mode operation

Dashed line Z indicates a reflection characteristic at the input/output terminal 9102 during the even-mode operation

As apparent from FIG. 5A, the curve of the reflection characteristic at the common terminal 9101 during the even-mode operation as indicated by the solid line Y, and the curve of the reflection characteristic at the input/output terminal 9102 during the even-mode operation as indicated by the dashed line Z, pass the center (at a zero point of a reflection coefficient) of the Smith chart. This point is for the normalized frequency of 1 as shown in FIG. 3A.

Meanwhile, as apparent from FIG. 5B, the reflection characteristic at the common terminal 9101 during the even-mode operation as indicated by the solid line Y, and the reflection characteristic at the input/output terminal 9102 during the even-mode operation as indicated by the dashed line Z, are plotted around the center (at a zero point of a reflection coefficient) of the Smith chart. This means that the frequency band that ensures satisfactory reflection is extended.

In the simulation described above, the impedance value Z0 of the load impedance 8102 is 50Ω, the resistance value R′ of the isolation resistor 4111 is 50Ω, the impedance value Za of the transmission line 11210 is 50Ω, the impedance value Zb of the transmission line 1122 is 50Ω, the impedance value Zc of the transmission line 1121e is 140Ω, and the impedance value 2Z0 of the load impedance 8111 is 100Ω.

As understood from the description above, according to the power divider/combiner of the first embodiment, in the coupling line 3101 formed by the transmission line 1121 and the transmission line 1131, the impedances of the transmission line 11210 and the transmission line 1121e during the even-mode operation and the odd-mode operation, are adjusted for each mode, to thereby achieve a satisfactory reflection characteristic at the input/output terminal 9102 during the odd-mode operation, a satisfactory reflection characteristic at the common terminal 9101 during the even-mode operation, and a satisfactory reflection characteristic at the input/output terminal 9102 during the even-mode operation over a wide band.

As an advantageous effect produced from the configuration described above, a power divider/combiner can be achieved, which has several satisfactory reflection characteristics and a satisfactory isolation characteristic over a wide band, during the power dividing operation and the power combining operation.

In the first embodiment, the chip resistor is used as the isolation resistor by way of example, but the present invention is not limited thereto, and a thin-film resistor may be used to obtain similar effects.

### Second Embodiment

In the first embodiment described above, the description is given of the example in which the total length of the transmission line 1121 and the transmission line 1122 is the same as that of the transmission line 1131 and the transmission line 1132, and the total length is any natural number of times longer than the half wavelength of the operating frequency. However, the present invention is not limited thereto, and is applicable to a power divider/combiner configured such that a connection is made via two transmission lines that have electrical lengths equal to or less than a quarter wavelength, and also are partially arranged in parallel and close to each other.

FIG. 6A is a perspective view of a power divider/combiner according to a second embodiment of the present invention, in which two transmission lines between respective input/output terminals and an isolation resistor have electrical lengths that are equal to or less than the quarter wavelength, and are at least partially arranged in parallel and close to each other. FIG. 6B is a top view of the power divider/combiner according to the second embodiment of the present invention, in which the two transmission lines between the respective input/output terminals and the isolation resistor have electrical lengths that are equal to or less than the quarter wavelength, and are at least partially arranged in parallel and close to each other.

In the power divider/combiner of FIG. 6A and FIG. 6B, the transmission line strip conductor 1021, the transmission line strip conductor 1022, the transmission line strip conductor 1031, and the transmission line strip conductor 1032 of the first embodiment described above are replaced with a transmission line strip conductor 1021s, a chip mounting pad 1022s, a transmission line strip conductor 1031s, and a chip mounting pad 1032s, respectively.

Further, the power divider/combiner is configured such that a total electrical length of the transmission line strip conductor 1021s and the chip mounting pad 1022s, and a total electrical length of the transmission line strip conductor 1031s and the chip mounting pad 1032s are equal to or less than a quarter wavelength.

Further, the coupling line 3001 in the first embodiment described above is replaced with a coupling line 3001s in FIG. 6A and FIG. 6B, and the transmission line strip conductor 1021s and the transmission line strip conductor 1031s are arranged in parallel and close to each other.

In the power divider/combiner of FIG. 6A and FIG. 6B, when the chip resistor 4001 of a large size is employed, the chip mounting pad 1022s and the chip mounting pad 1032s are accordingly upsized, to thereby generate parasitic capacitance. However, a high-frequency characteristic is rarely deteriorated by the parasitic capacitance. This enables a low-loss power divider/combiner.

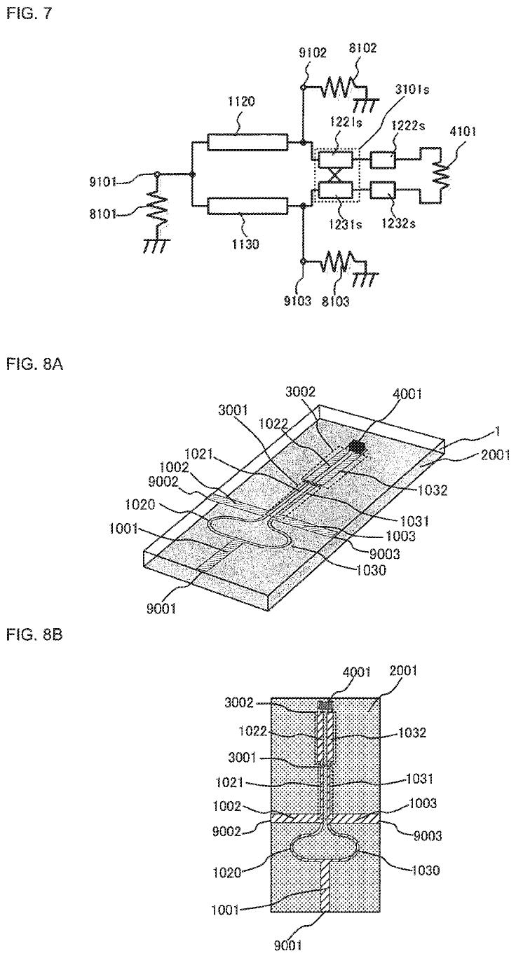

FIG. 7 is an equivalent circuit diagram of the power divider/combiner according to the second embodiment of the present invention as illustrated in FIG. 6A and FIG. 6B. As understood from comparison between the configuration views of FIG. 6A and FIG. 6B and the equivalent circuit diagram of FIG. 7, the transmission line strip conductor 1021s, the chip mounting pad 1022s, the transmission line strip conductor 1031s, the chip mounting pad 1032s, and the coupling line 3001 are replaced with a transmission line 1121s, a transmission line 1122s, a transmission line 1131s, a transmission line 1132s, and a coupling line 3101s, respectively.

Other components can be each replaced and assigned a corresponding reference symbol as with the replacement of the components in the configuration views of FIG. 1A and FIG. 1B with those in the equivalent circuit diagram of FIG. 2.

According to the power divider/combiner of the second embodiment, the two transmission lines between the respective input/output terminals and the isolation resistor have electrical lengths equal to or less than the quarter wavelength, and the transmission line 1121s and the transmission line 1131s that form the coupling line 3101, out of the transmission lines, are each adjusted to have suitable impedances during the even/odd-mode operation, to thereby suppress an influence of the impedances generated in the transmission line 1121s and the transmission line 1131s. This enables a low-loss power divider/combiner.

### Third Embodiment

In the first embodiment described above, the description is given of the power divider/combiner configured such that the two transmission lines between the respective input/output terminals and the isolation resistor have electrical lengths that are any natural number of times longer than the half wavelength, and the transmission lines are at least partially arranged in parallel and close to each other. However, the present invention is not limited thereto, and is applicable to a power divider/combiner in which all of such transmission lines form a coupling line.

FIG. 8A is a perspective view of a power divider/combiner according to a third embodiment of the present invention, in which two transmission lines between respective input/output terminals and an isolation resistor are entirely arranged in parallel and close to each other. FIG. 8B is a top view of the power divider/combiner according to the third embodiment of the present invention, in which the two transmission lines between the respective input/output terminals and the isolation resistor are entirely arranged in parallel and close to each other.

In the power divider/combiner of FIG. 8A and FIG. 8B, the transmission line strip conductor 1022 and the transmission line strip conductor 1032 as in the first embodiment described above are arranged in parallel and close to each other, to thereby form a coupling line 3002.

In the power divider/combiner of FIG. 8, the transmission line strip conductor 1022 and the transmission line strip conductor 1032 of the coupling line 3002 can be each adjusted to have a suitable impedance during an even/odd-mode operation. As such, the power divider/combiner configured as in the third embodiment can have a higher degree of design freedom, and also produce similar effects to those in the first embodiment.

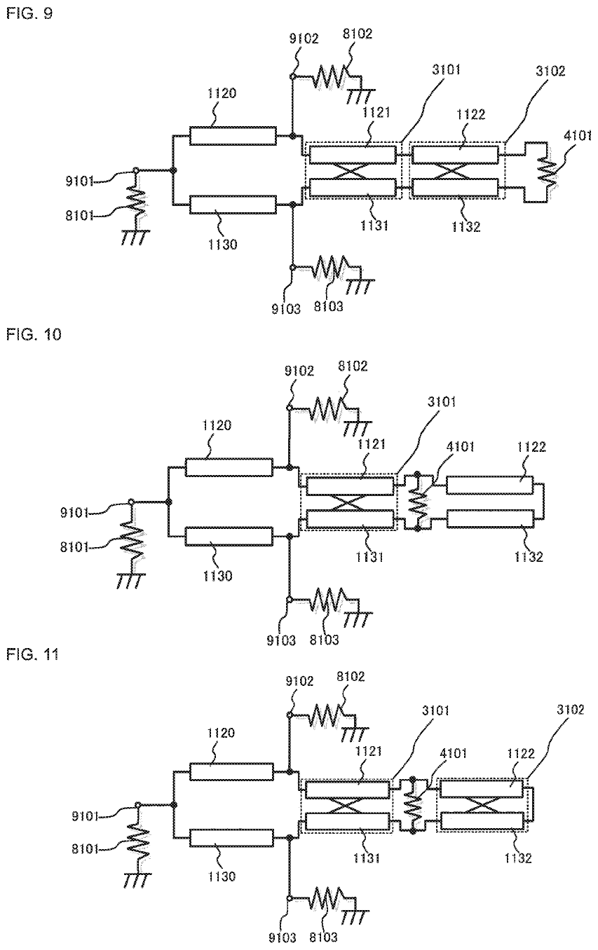

FIG. 9 is an equivalent circuit diagram of the power divider/combiner according to the third embodiment of the present invention as illustrated in FIG. 8A and FIG. 8B. As understood from comparison between the configuration views of FIG. 8A and FIG. 8B and the equivalent circuit diagram of FIG. 9, the coupling line 3001 is replaced with a coupling line 3101. Other components can be each replaced and assigned a corresponding reference symbol as with the replacement of the components in the configuration views of FIG. 1A and FIG. 1B with those in the equivalent circuit diagram of FIG. 2.

According to the power divider/combiner of the third embodiment, the two transmission lines between the respective input/output terminals and the isolation resistor have electrical lengths that are any natural number of times longer than the half wavelength, and the transmission lines are entirely arranged in parallel and close to each other, so that the transmission line 1121 and the transmission line 1131 form a coupling line 3101, and the transmission line 1122 and the transmission line 1132 form a coupling line 3102.

With this configuration, it is possible to adjust the impedances of the transmission line strip conductor 1021 and the transmission line strip conductor 1031 of the coupling line 3001 during the even/odd-mode operation, and the impedances of the transmission line strip conductor 1022 and the transmission line strip conductor 1032 of the coupling line 3002 during the even/odd-mode operation. Consequently, the power divider/combiner can have a higher degree of design freedom, and also produce similar effects to those in the first embodiment described above.

### Fourth Embodiment

In the first embodiment and third embodiment described above, the description is given of the power divider/combiner in which the input/output terminal 9102 and the isolation resistor 4101, and the input/output terminal 9103 and the isolation resistor 4101 are connected to each other via the transmission lines having electrical lengths that are any natural number of times longer than the half wavelength.

The present invention is also applicable to a power divider/combiner in which the input/output terminal 9102 and the isolation resistor 4101, and the input/output terminal 9103 and the isolation resistor 4101 are connected to each other via transmission lines having electrical lengths that are an odd multiple of a quarter wavelength, and in addition, a transmission line having an electrical length that is an odd multiple of one wavelength is connected in parallel to the isolation resistor 4101. In a fourth embodiment of the present invention, this configuration is described in detail.

FIG. 10 is an equivalent circuit diagram of a power divider/combiner according to the fourth embodiment of the present invention. In an example of the fourth embodiment illustrated in FIG. 10, the isolation resistor 4101 has one end connected between the transmission line 1121 and the transmission line 1122, and has another end connected between the transmission line 1131 and the transmission line 1132.

Further, an end of the transmission line 1122 that is not connected to the isolation resistor 4101 is connected to an end of the transmission line 1132 that is not connected to the isolation resistor 4101. In other words, the transmission line formed by the cascaded transmission line 1122 and transmission line 1132 is connected in parallel to the isolation resistor 4101.

According to the fourth embodiment, the transmission line formed by the cascaded transmission line 1122 and transmission line 1132 is connected in parallel to the isolation resistor 4101, so that a mounting position of the isolation resistor 4101 can be adjusted in accordance with a target layout. Hence, the power divider/combiner of the fourth embodiment can have a higher degree of design freedom, and also produce similar effects to those in the first embodiment described above.

In the example of the fourth embodiment illustrated in FIG. 10, the transmission line 1122 and the transmission line 1132 are general transmission lines, but the present invention is not limited thereto. The transmission line 1122 and the transmission line 1132 may be arranged in parallel and close to each other, to thereby form a coupling line 3102.

FIG. 11 is an equivalent circuit diagram of the power divider/combiner according to the fourth embodiment of the present invention, in which the transmission line 1122 and the transmission line 1132 are arranged in parallel and close to each other, to thereby form the coupling line 3102.

With the power divider/combiner illustrated in FIG. 11, it is possible to adjust the impedances of the transmission line strip conductor 1021 and the transmission line strip conductor 1031 of the coupling line 3001 during the even/odd-mode operation, and the impedances of the transmission line strip conductor 1022 and the transmission line strip conductor 1032 of the coupling line 3002 during the even/odd-mode operation. Consequently, the power divider/combiner can have a higher degree of design freedom, and also produce similar effects to those in the example described above.

### Fifth Embodiment

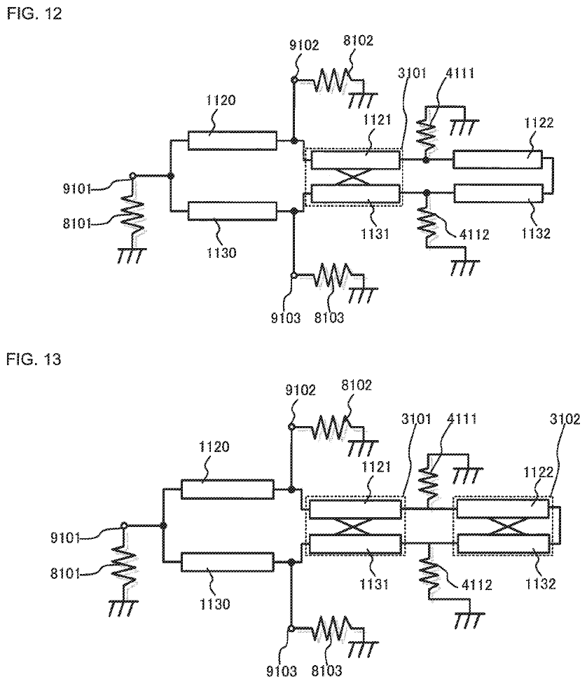

In the first, third, and fourth embodiments described above, the Wilkinson power divider/combiner is described, but a Gysel power divider/combiner can be used instead. FIG. 12 is an equivalent circuit diagram of a power divider/combiner according to a fifth embodiment of the present invention.

In an example of the fifth embodiment illustrated in FIG. 12, two isolation resistors, namely, an isolation resistor 4111 and an isolation resistor 4112 are employed. In this example, the isolation resistor 4111 has one end connected between the transmission line 1121 and the transmission line 1122, and has another end grounded, and the isolation resistor 4112 has one end connected between the transmission line 1131 and the transmission line 1132, and has another end grounded.

Further, an end of the transmission line 1122 that is not connected to the isolation resistor 4111 is connected to an end of the transmission line 1132 that is not connected to the isolation resistor 4112.

According to the configuration of the fifth embodiment, the two isolation resistors are provided, and the one ends of the isolation resistor 4111 and the isolation resistor 4112 are grounded. This configuration ensures a higher electric power resistance, and also produces similar effects to those in the first embodiment described above.

In the example of the fifth embodiment illustrated in FIG. 12, the transmission line 1122 and the transmission line 1132 are general transmission lines, but the present invention is not limited thereto. The transmission line 1122 and the transmission line 1132 may be arranged in parallel and close to each other, to thereby form a coupling line 3102.

FIG. 13 is an equivalent circuit diagram of the power divider/combiner according to the fifth embodiment of the present invention, in which the transmission line 1122 and the transmission line 1132 are arranged in parallel and close to each other, to thereby form the coupling line 3102.

With the power divider/combiner illustrated in FIG. 13, it is possible to adjust the impedances of the transmission line strip conductor 1021 and the transmission line strip conductor 1031 of the coupling line 3001 during the even/odd-mode operation, and the impedances of the transmission line strip conductor 1022 and the transmission line strip conductor 1032 of the coupling line 3002 during the even/odd-mode operation. Consequently, the power divider/combiner can have a higher degree of design freedom, and also produce similar effects to those in the example described above.

### Sixth Embodiment

In the first, third, fourth, and fifth embodiments described above, the description is given of the power divider/combiner in which the two transmission lines between the respective input/output terminals and the isolation resistor are at least partially arranged in parallel and close to each other, to thereby form the coupling line, and the transmission lines that form the coupling line can be each adjusted to have suitable impedances during the even/odd-mode operation.

Alternatively, the present invention is applicable to a power divider/combiner including two transmission lines between respective input/output terminals and an isolation resistor, which do not form a coupling line, but satisfy the conditions adopted for the odd-mode operation in the first, third, fourth, and fifth embodiments described above. In a sixth embodiment of the present invention, this configuration is described in detail.

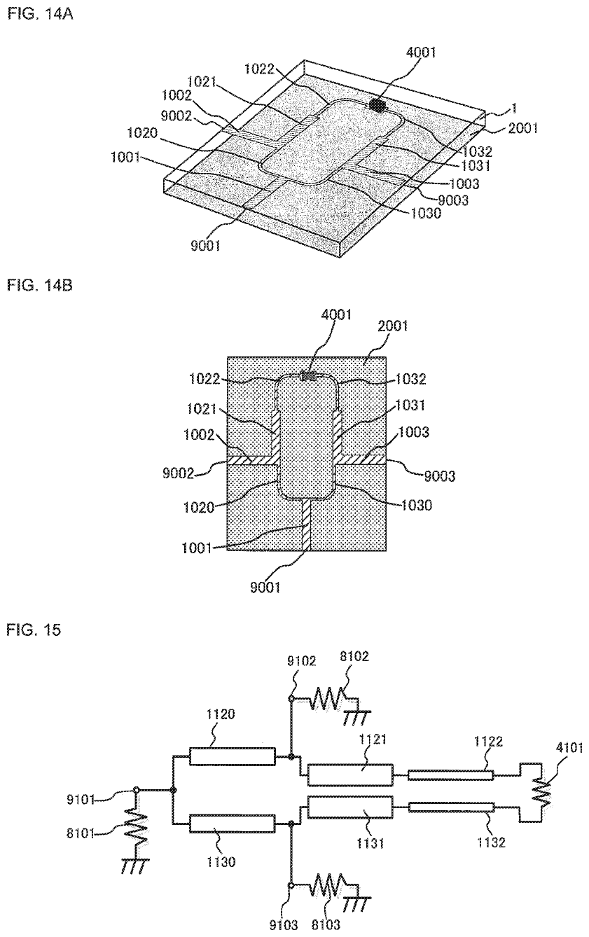

FIG. 14A is a perspective view of a power divider/combiner according to the sixth embodiment of the present invention, in which two transmission lines between respective input/output terminals and an isolation resistor satisfy Expression (1) and Expression (2), and any one of Expressions (3) to (6). FIG. 14B is a top view of the power divider/combiner according to the sixth embodiment of the present invention, in which the two transmission lines between the respective input/output terminals and the isolation resistor satisfy Expression (1) and Expression (2), and any one of Expressions (3) to (6).

In the power divider/combiner of FIG. 14A and FIG. 14B, the transmission line strip conductor 1021 and the transmission line strip conductor 1031, and the transmission line strip conductor 1022 and the transmission line strip conductor 1032 are physically apart from each other so as not to cause electrical coupling.

FIG. 15 is an equivalent circuit diagram of the power divider/combiner according to the sixth embodiment of the present invention as illustrated in FIG. 14A and FIG. 14B. Respective components can be each replaced and assigned a corresponding reference symbol as with the replacement of the components in the configuration views of FIG. 1A and FIG. 1B with those in the equivalent circuit diagram of FIG. 2.

In the power divider/combiner of FIG. 15, the transmission line 1121, the transmission line 1122, the transmission line 1131, and the transmission line 1132 are designed to satisfy Expression (1) and Expression (2), and any one of Expressions (3) to (6) as given above so as to operate as quarter-wavelength impedance transformers. In Expressions given above, “Za” represents an impedance of each of the transmission line 1121 and the transmission line 1131, “Zb” represents an impedance of each of the transmission line 1122 and the transmission line 1132, “Z0” represents an impedance of each of the load impedance 8102 and the load impedance 8103, and “R′” represents a resistance value that is half the resistance value of the isolation resistor 4101.

As a result, compared to the related-art power divider/combiner, a power divider/combiner can be achieved, which has several satisfactory reflection characteristics and a satisfactory isolation characteristic over a wide band, during the power dividing operation and the power combining operation.

### Seventh Embodiment

In the first to sixth embodiments described above, the power divider/combiner that employs microstrip lines is described. However, the present invention is also applicable to a power divider/combiner that employs strip lines. In a seventh embodiment of the present invention, this configuration is described in detail.

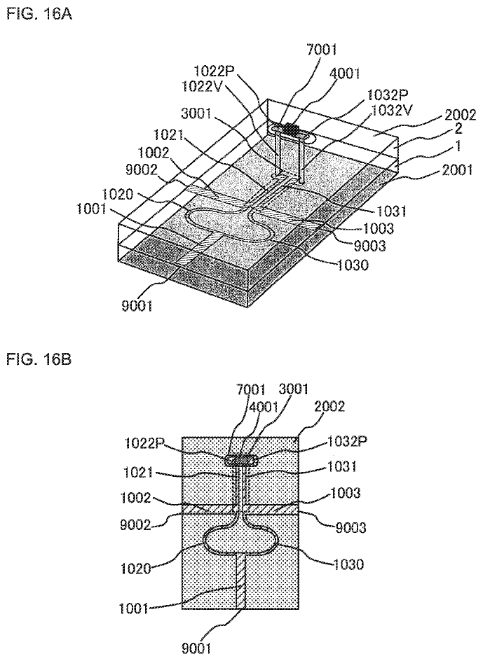

FIG. 16A is a perspective view of a power divider/combiner according to the seventh embodiment of the present invention, in which strip lines are employed. FIG. 16B is a top view of the power divider/combiner according to the seventh embodiment of the present invention, in which the strip lines are employed. The strip lines used herein are configured such that a dielectric layer and an external ground conductor are provided on the strip conductors of the microstrip lines as described in each of the examples above.

In the power divider/combiner of FIG. 16A and FIG. 16B, the common strip conductor 1001, the input/output strip conductor 1002, the input/output strip conductor 1003, the quarter-wavelength impedance transformer strip conductor 1020, the quarter-wavelength impedance transformer strip conductor 1030, the transmission line strip conductor 1021, and the transmission line strip conductor 1031 in the first embodiment described above are each formed by a strip line as an internal conductor. Those internal conductors are located between the dielectric layer 1 and a dielectric layer 2.

The ground conductor 2001 hatched with dots is disposed on a surface of the dielectric layer 1 that is opposite to the one on which the dielectric layer 2 is provided, and a ground conductor 2002 is disposed on a surface of the dielectric layer 2 that is opposite to the one on which the dielectric layer 1 is provided.

The chip resistor 4001 is mounted on a chip mounting pad 1022P and a chip mounting pad 1032P which are provided in a cutout 7001 formed in the ground conductor 2002, and is also connected to the transmission line strip conductor 1021 and the transmission line strip conductor 1031 through a via 1022V and a via 1032V, respectively.

Here, an electrical length of the transmission line corresponding to the chip mounting pad 1022P and the via 1022V is the same as that of the transmission line corresponding to the chip mounting pad 1032P and the via 1032V, and those electrical lengths are an odd multiple of a quarter wavelength.

According to the seventh embodiment, it is possible, by employing the strip lines, to suppress electromagnetic interference with the outside of the substrate, and also to produce similar effects to those in the first embodiment described above.

In the example of the seventh embodiment illustrated in FIG. 16A and FIG. 16B, the electrical length of the transmission line corresponding to the chip mounting pad 1022P and the via 1022V is defined in the surface layer of the dielectric substrate by way of example, but the present invention is not limited thereto. The present invention is also applicable to a configuration in which such an electrical length is defined in an inner layer of the dielectric substrate. This configuration ensures a higher degree of design freedom of the power divider/combiner, and also produces similar effects to those of the example described above.

The first to seventh embodiments described above can be summarized as follows. That is, according to the present invention, it is possible to employ the configuration in which the Wilkinson power divider/combiner is provided on the dielectric substrate. In the power divider/combiner according to the present invention, the dielectric substrate has formed thereon the strip conductor patterns that form the quarter-wavelength impedance transformers, and has mounted thereon the chip resistor that serves as the isolation resistor.

The strip conductor patterns and the chip resistor are connected via the two transmission lines formed of the strip conductor. The two transmission lines have electrical lengths that are half the wavelength of the operating frequency, and some portions of the transmission lines, which correspond to the quarter wavelength, are arranged in parallel and close to each other, to thereby form the coupling line.

In this case, in the even/odd-mode operation of the power divider/combiner, the impedance of the coupling line is set to any value in a range from the load impedance at each input/output terminal to half the resistance value of the isolation resistor during the odd-mode operation, and is set higher than the load impedance at each input/output terminal during the even-mode operation.

This configuration ensures satisfactory reflection characteristics at the common terminal and the respective input/output terminals, and satisfactory isolation between the input/output terminals over a wide band.

The present invention is not limited to the power divider/combiner in which the two transmission lines, which are formed of strip conductors and configured to connect the strip conductor patterns and the chip resistor, have electrical lengths that are half the wavelength of the operating frequency. The power divider/combiner may be configured such that the two transmission lines have electrical lengths that are any natural number of times longer than the half wavelength, and the two transmission lines are arranged in parallel and close to each other, to thereby form the coupling line.

Similarly to the above, in the even/odd-mode operation of the power divider/combiner, the impedance of the coupling line is set to half the resistance value of the isolation resistor during the odd-mode operation, and is set higher than the resistance value of the isolation resistor during the even-mode operation. This configuration ensures satisfactory reflection characteristics at the common terminal and the respective input/output terminals, which are engaged in the even/odd-mode operation, over a wide band.

Consequently, it is possible to maintain satisfactory reflection characteristics at the common terminal and the respective input/output terminals, and satisfactory isolation between the input/output terminals during the power dividing operation and the power combining operation over a wide band.

The power divider/combiner according to the present invention is not limited to the Wilkinson power divider/combiner provided on the dielectric substrate, but may be a Gysel power divider/combiner provided on a multilayer substrate.

Similarly to the Wilkinson power divider/combiner, in the Gysel power divider/combiner, a dielectric substrate has formed thereon strip conductor patterns that form quarter-wavelength impedance transformers, and also has mounted thereon two chip resistors as isolation resistors.

Further, input/output terminals of the strip conductor patterns that form the quarter-wavelength impedance transformers are connected to each other via a strip conductor pattern having an electrical length corresponding to one wavelength (A), and also, branch points to be connected to one ends of the respective chip resistors are formed on the strip conductor patterns which have electrical lengths corresponding to one wavelength, and are located away from the respective input/output terminals by the quarter wavelength.

Further, another ends of the respective chip resistors connected to the branch points, are grounded. Further, the branch points to which the one ends of the chip resistors are connected, and the respective input/output terminals are connected via the two transmission lines that are arranged in parallel and close to each other to form the coupling line.

Similarly to the Wilkinson power divider/combiner, in the even/odd-mode operation of the power divider/combiner, the impedance of the coupling line is set to half the resistance value of the isolation resistor during the odd-mode operation, and is set higher than the resistance value of the isolation resistor during the even-mode operation. This configuration ensures satisfactory reflection characteristics at the common terminal and the respective input/output terminals, which are engaged in the even/odd-mode operation, over a wide band.

Consequently, it is possible to maintain satisfactory reflection characteristics at the common terminal and the respective input/output terminals, and satisfactory isolation between the input/output terminals during the power dividing operation and the power combining operation over a wide band.

A free combination of the embodiments, a modification of a suitable component in each of the embodiments, or omission of a suitable component in each of the embodiments is possible in the present invention within the scope of the invention.

### REFERENCE SIGNS LIST

1, 2 dielectric layer, 1001 common strip conductor, 1002, 1003 input/output strip conductor, 1020, 1030 quarter-wavelength impedance transformer strip conductor, 1022s, 1032s, 1022P, 1032P chip mounting pad, 1022V, 1032V via, 1120, 1130 quarter-wavelength impedance transformer, 1021, 1022, 1031, 1032, 1021s, 1031s transmission line strip conductor, 1121, 1122, 1131, 1132, 1121o, 1121e transmission line, 2001, 2002 ground conductor, 3001, 3002, 3101, 3102, 3001s coupling line, 4001, chip resistor, 4101, 4111, 4112 isolation resistor, 6000 arrow (open), 7001 cutout, 8101, 8102, 8103, 8111 load impedance, 9001, 9101 common terminal, 9002, 9003, 9102, 9103 input/output terminal

1-15. (canceled)

16. A power divider/combiner, comprising:
a common terminal, to which a high-frequency signal to be divided is input, or from which a synthesized high-frequency signal is output;
a first input/output terminal and a second input/output terminal, from which divided high-frequency signals are output, or to which high-frequency signals to be synthesized are input;
a first impedance transformer having one end connected to the common terminal and another end connected to the first input/output terminal;
a second impedance transformer having one end connected to the common terminal and another end connected to the second input/output terminal;
an isolation resistor configured to avoid interference between a high-frequency signal at the first input/output terminal and a high-frequency signal at the second input/output terminal;
a first transmission line and a second transmission line, which are configured to connect the isolation resistor and the first input/output terminal; and
a third transmission line and a fourth transmission line, which are configured to connect the isolation resistor and the second input/output terminal,
the first transmission line and the second transmission line being cascaded,
the third transmission line and the fourth transmission line being cascaded,
the first transmission line and the third transmission line being arranged in parallel and close to each other, and also being electrically coupled to form a first coupling line.

17. The power divider/combiner according to claim 16, wherein an electrical length of a transmission line obtained by combining the first transmission line and the second transmission line, and an electrical length of a transmission line obtained by combining the third transmission line and the fourth transmission line are shorter than a quarter wavelength of a predetermined frequency.

18. The power divider/combiner according to claim 16, wherein, when a load impedance at the first input/output terminal and a load impedance at the second input/output terminal are represented by “Z0”, and a value that is half a resistance value of the isolation resistor is represented by “R”, an impedance of the first transmission line and an impedance of the third transmission line are higher than Z0 during an even-mode operation, and are in a range of from Z0 to R′ during an odd-mode operation.

19. The power divider/combiner according to claim 16, wherein the second transmission line and the fourth transmission line are arranged in parallel and close to each other, and also are electrically coupled to form a second coupling line.

20. The power divider/combiner according to claim 16, wherein, when an impedance of the first transmission line and an impedance of the third transmission line during an odd-mode operation are represented by “Za”, and a value that is half a resistance value of the isolation resistor is represented by “R”, an impedance of the second transmission line and an impedance of the fourth transmission line are in a range of from Za to R′.

21. The power divider/combiner according to claim 16, wherein an electrical length of the first transmission line, an electrical length of the second transmission line, an electrical length of the third transmission line, and an electrical length of the fourth transmission line are an even multiple of a quarter wavelength of a predetermined frequency.

22. The power divider/combiner according to claim 16, wherein an electrical length of the first transmission line, an electrical length of the second transmission line, an electrical length of the third transmission line, and an electrical length of the fourth transmission line are an odd multiple of a quarter wavelength of a predetermined frequency.

23. The power divider/combiner according to claim 16, further comprising a dielectric substrate including:
strip conductors, which are provided in a surface layer of the dielectric substrate and configured to form the terminals, the transformers, the transmission lines, and the coupling line; and
a chip resistor, which is surface-mounted to dielectric substrate and configured to form the isolation resistor.

24. The power divider/combiner according to claim 16, further comprising a multilayer substrate including:
strip conductors, which are provided in an inner layer of the multilayer substrate and configured to form the terminals, the transformers, the transmission lines, and the coupling line;
a chip resistor, which is surface-mounted to the multilayer substrate and configured to form the isolation resistor; and
vertical connection conductors configured to connect the strip conductors and the chip resistor.

25. The power divider/combiner according to claim 16, further comprising a multilayer substrate including:
strip conductors, which are provided in an inner layer of the multilayer substrate and configured to form the terminals, the transformers, the transmission lines, and the coupling line;
a chip resistor, which is provided in the inner layer of the multilayer substrate and configured to form the isolation resistor; and
vertical connection conductors configured to connect the strip conductors and the chip resistor.

26. A power divider/combiner, comprising:
a common terminal, to which a high-frequency signal to be divided is input, or from which a synthesized high-frequency signal is output;
a first input/output terminal and a second input/output terminal, from which divided high-frequency signals are output, or to which high-frequency signals to be synthesized are input;
a first impedance transformer having one end connected to the common terminal and another end connected to the first input/output terminal;
a second impedance transformer having one end connected to the common terminal and another end connected to the second input/output terminal;
an isolation resistor configured to avoid interference between a high-frequency signal at the first input/output terminal and a high-frequency signal at the second input/output terminal;
a first transmission line configured to connect one end of the isolation resistor and the first input/output terminal;
a third transmission line configured to connect another end of the isolation resistor and the second input/output terminal;
a second transmission line having one end connected to a node between the isolation resistor and the first transmission line; and
a fourth transmission line having one end connected to a node between the isolation resistor and the third transmission line,
another end of the second transmission line and another end of the fourth transmission line being connected to each other,
the first transmission line and the third transmission line being arranged in parallel and close to each other, and also being electrically coupled to form a first coupling line.

27. The power divider/combiner according to claim 26, wherein, when a load impedance at the first input/output terminal and a load impedance at the second input/output terminal are represented by “Z0”, and a value that is half a resistance value of the isolation resistor is represented by “R”, an impedance of the first transmission line and an impedance of the third transmission line are higher than Z0 during an even-mode operation, and are in a range of from Z0 to R′ during an odd-mode operation.

28. The power divider/combiner according to claim 26,
wherein the isolation resistor includes a first isolation resistor and a second isolation resistor,
wherein the first transmission line is configured to connect one end of the first isolation resistor and the first input/output terminal,
wherein the second transmission line has one end connected to a node between the one end of the first isolation resistor and the first transmission line,
wherein the third transmission line is configured to connect one end of the second isolation resistor and the second input/output terminal,
wherein the fourth transmission line has one end connected to a node between the one end of the second isolation resistor and the third transmission line, and
wherein another end of the first isolation resistor and another end of the second isolation resistor are grounded.

29. The power divider/combiner according to claim 28, wherein, when a load impedance at the first input/output terminal and a load impedance at the second input/output terminal are represented by “Z0”, and a resistance value of the first isolation resistor and a resistance value of the second isolation resistor are represented by “R”, an impedance of the first transmission line and an impedance of the third transmission line are higher than Z0 during an even-mode operation, and are in a range of from Z0 to R′ during an odd-mode operation.

30. The power divider/combiner according to claim 28, wherein, when an impedance of the first transmission line and an impedance of the third transmission line during an odd-mode operation are represented by “Za”, and a resistance value of the first isolation resistor and a resistance value of the second isolation resistor are represented by “R”, an impedance of the second transmission line and an impedance of the fourth transmission line are in a range of from Za to R′.

31. The power divider/combiner according to claim 26, wherein an electrical length of the first transmission line, an electrical length of the second transmission line, an electrical length of the third transmission line, and an electrical length of the fourth transmission line are an even multiple of a quarter wavelength of a predetermined frequency.

32. A power divider/combiner, comprising:
a common terminal, to which a high-frequency signal to be divided is input, or from which a synthesized high-frequency signal is output;
a first input/output terminal and a second input/output terminal, from which divided high-frequency signals are output, or to which high-frequency signals to be synthesized are input;
a first impedance transformer having one end connected to the common terminal and another end connected to the first input/output terminal;
a second impedance transformer having one end connected to the common terminal and another end connected to the second input/output terminal;
an isolation resistor configured to avoid interference between a high-frequency signal at the first input/output terminal and a high-frequency signal at the second input/output terminal;
a first half-wavelength line configured to connect the isolation resistor and the first input/output terminal; and
a second half-wavelength line configured to connect the isolation resistor and the second input/output terminal,
the first half-wavelength line including a first transmission line and a second transmission line,
the second half-wavelength line including a third transmission line and a fourth transmission line,
wherein, when a load impedance at the first input/output terminal and a load impedance at the second input/output terminal are represented by “Z0”, and a value that is half a resistance value of the isolation resistor is represented by “R”, an impedance of the first transmission line and an impedance of the third transmission line are in a range of from Z0 to R′, and an impedance of the second transmission line and an impedance of the fourth transmission line are in a range of from Za to R′, where “Za” represents the impedance of the first transmission line and the impedance of the third transmission line, and
wherein the first transmission line, the second transmission line, the third transmission line, and the fourth transmission line each operate as an impedance transformer.

33. The power divider/combiner according to claim 32, wherein an electrical length of the first transmission line, an electrical length of the second transmission line, an electrical length of the third transmission line, and an electrical length of the fourth transmission line are an even multiple of a quarter wavelength of a predetermined frequency.
